(19) United States
(12) Patent Application Publication
(10) Pub. No.: US 2016/0370849 A1
(43) Pub. Date: Dec. 22, 2016

(54) APPARATUS AND METHOD FOR CONTROLLING HOTPLUG BASED ON LOAD PROPERTY OF MULTI-CORE SYSTEM

(71) Applicant: Electronics and Telecommunications Research Institute, Daejeon (KR)

(72) Inventor: Jin Ho ON, Jeollabuk-do (KR)

(21) Appl. No.: 15/177,907

(22) Filed: Jun. 9, 2016

(30) Foreign Application Priority Data
Jun. 16, 2015 (KR) 10-2015-0085297

(51) Int. Cl. G06F 1/32

(52) U.S. Cl. CPC G06F 1/3287

(57) ABSTRACT

Disclosed is an apparatus for controlling hotplug based on load properties of a multi-core system, the apparatus including: a load measurer configured to measure loads of two or more cores constituting a multi-core, and to determine types of the measured loads of the two or more cores; and a hotplug processor configured to determine an optimal number of cores by calculating an average amount of load from the measured loads of the two or more cores, and by comparing the calculated average amount of load and the determined types of the measured loads with a control table that stores a number of operations of cores according to types of loads.

### CROSS-REFERENCE TO RELATED APPLICATION(S)

This application claims priority from Korean Patent Application No. 10-2015-0085297, filed on Jun. 16, 2015, in the Korean Intellectual Property Office, the entire disclosure of which is incorporated herein by reference for all purposes.

### BACKGROUND

1. Field

The following description relates generally to a system for controlling a multi-core processor and more particularly to a system for controlling hotplug of a multi-core processor.

2. Description of the Related Art

With the development of Information Technology (IT), various IT devices have been developed and widely used in many applications in everyday lives. As the IT devices are required to have high performance, a single-core processor that operates the IT devices has been developed into a multi-core processor having two or more cores. Such multi-core processor increases performance of IT devices, but the power consumption also increases significantly. In order to solve the problem, there have been suggested many methods, such as frequency control, idle state transition, and hotplug, that reduce power consumption of IT devices. However, the methods are difficult to be applied for general use, since the methods may lead to different results depending on processor architecture. Korean Laid-open Patent Publication No. 10-2012-0095507 discloses a hot-plugging method which controls ON/OFF operations of cores by merely considering the load size of cores without reflecting the load properties.

### SUMMARY

Provided is an apparatus and method for controlling hotplug based on load properties, which may maintain an optimal core state by considering the types of loads of a system.

In one general aspect, there is provided an apparatus for controlling hotplug based on load properties, the apparatus including: a load measurer configured to measure loads of two or more cores constituting a multi-core, and to determine types of the measured loads of the two or more cores; and a hotplug processor configured to determine an optimal number of cores by calculating an average amount of load from the measured loads of the two or more cores, and by comparing the calculated average amount of load and the determined types of the measured loads with a control table that stores a number of operations of cores according to types of loads.

The apparatus may further include a table generator configured to generate the control table by generating reference loads which are divided into types, applying the generated reference loads to the two or more cores constituting the multi-core, and measuring a throughput of operations of each of the two or more cores, to which the reference loads are applied.

At the initial state of a system, or in a case where there is no control table, the table generator may generate the control table.

Further, the types of the measured loads may be divided into a processor-intensive load and an I/O-intensive load.

The hotplug processor may determine whether to calculate an optimal number of cores depending on whether there is a power saving policy to reduce power consumption of the multi-core.

The hotplug processor may compare the average amount of load with the throughput of operations corresponding to the determined types of loads in the control table, may identify, from the control table, a minimum number of cores that process the calculated average amount of load, and may determine the minimum number of cores to be the optimal number of cores.

The hotplug processor may compare the determined optimal number of cores with a number of currently active cores to control each of the two or more cores.

In response to the optimal number of cores being smaller than the number of currently active cores, the hotplug processor may switch active cores to an inactive state, a number of the active cores being a number determined based on a difference between the optimal number of cores and the number of currently active cores.

In response to the average amount of load being identical to the throughput of operations in the control table, the hotplug processor may switch the inactive cores to an active state.

In another general aspect, there is provided a method of controlling hotplug based on load properties, the method including: generating a control table by generating reference loads which are divided into types, applying the generated reference loads to two or more cores constituting the multi-core, and measuring a throughput of operations of each of the cores, to which a maximum load is applied. Further, the method includes: measuring loads of the two or more cores constituting a multi-core; determining types of the measured loads of the two or more cores; calculating an average amount of load during a predetermined period of time; and upon calculating the average amount of load during a predetermined period of time, determining an optimal number of cores by comparing the calculated average amount of load and the determined types of the measured loads with a control table that stores a number of operations of cores according to types of loads. In addition, the method may further include switching some of the active cores to an inactive state based on the determined optimal number of cores.

### BRIEF DESCRIPTION OF THE DRAWINGS

FIG. 1 is a block diagram illustrating an apparatus for controlling hotplug based on load properties of a multi-core system according to an embodiment.

FIG. 2 is a diagram illustrating in detail an apparatus for controlling hotplug based on load properties of a multi-core system according to an embodiment.

FIG. 3 is a diagram illustrating an example of a control table of an apparatus for controlling hotplug based on load properties of a multi-core system according to an embodiment.

FIG. 4 is a flowchart illustrating a method of controlling hotplug that is performed by an apparatus for controlling hotplug based on load properties of a multi-core system according to an embodiment.

FIG. 5 is a diagram illustrating a method of generating a control table in a method of controlling hotplug based on load properties of a multi-core system according to an embodiment.

FIG. 6 is a flowchart illustrating another example of a method of controlling hotplug based on load properties of a multi-core system according to an embodiment.

### DETAILED DESCRIPTION

Hereinafter, the present disclosure will be described in detail with reference to the accompanying drawings. Terms used throughout this specification are defined in consideration of functions according to exemplary embodiments, and can be varied according to a purpose of a user or manager, or precedent and so on. Thus, the meanings of the terms used in the following embodiments shall follow the definitions if defined herein, otherwise shall have the same meaning as is commonly understood by one of ordinary skill in the art to which this invention belongs.

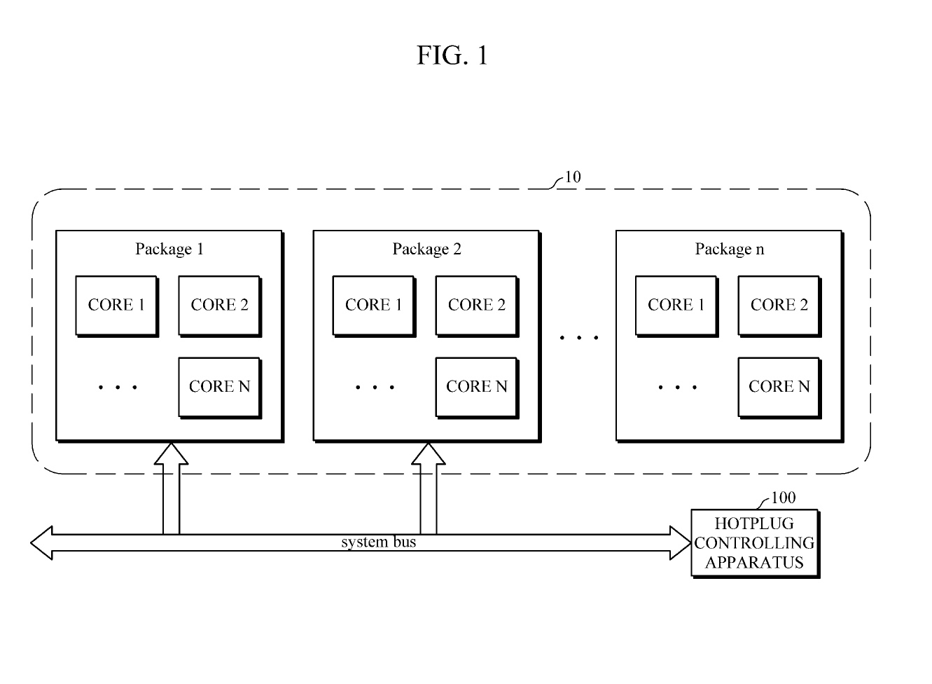

FIG. 1 is a block diagram illustrating an apparatus 100 for controlling hotplug based on load properties of a multi-core system according to an embodiment.

Referring to FIG. 1, the apparatus 100 for controlling hotplug based on load properties of a multi-core system (hereinafter referred to as a “hotplug controlling apparatus”) is based on a multi-core system, in which hot-plugging of a CPU 10, which is a package of one or more cores that may set various executable frequencies, may be performed to control each core. The hotplug controlling apparatus 100 may control ON/OFF operations of each core by collecting a load of each core, determining the types of collected loads of cores, comparing the determined types with a performance table, and determining an optimal core state. In the present disclosure, a load is indicated by a throughput of operations.

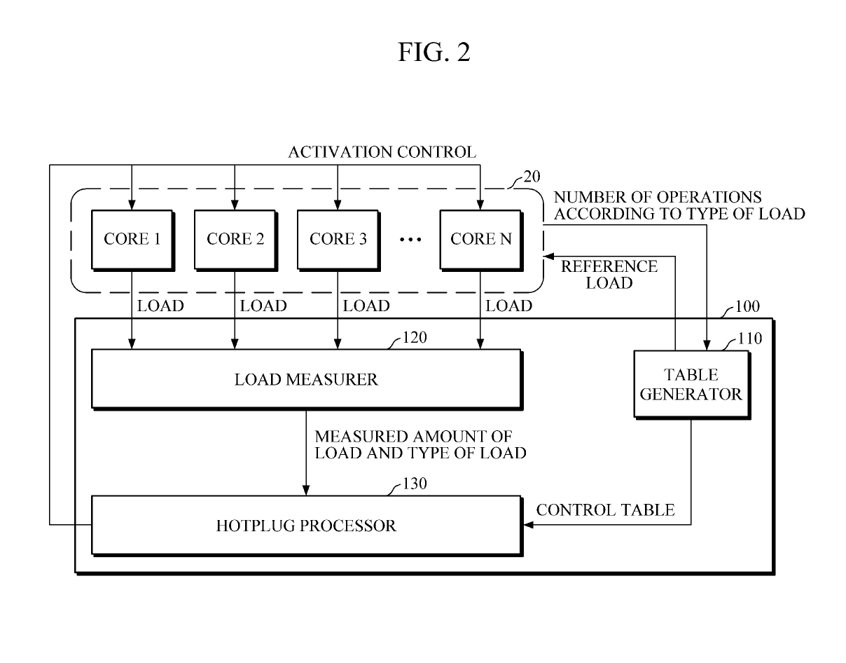

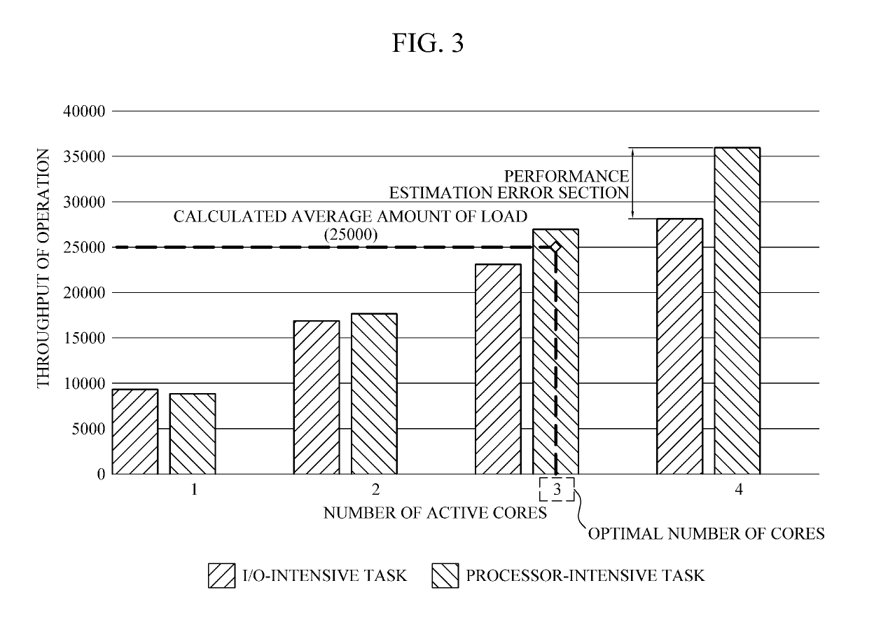

To this end, at the initial state of a system or in the case where there is no control table, the hotplug controlling apparatus 100 generates a reference load of a core. Then, the hotplug controlling apparatus 100 applies the generated reference load to each core to identify a throughput of executable operations, generates a control table based on the identified throughput and stores the control table. In the case where the load of an active core is 100%, the throughput of executable operations may be different depending on the types of loads. Particularly, the throughput of executable operations may be different depending on whether the type of a load applied to a core is a CPU-intensive load or an I/O-intensive load. Accordingly, the hotplug apparatus 100 applies, to each core, both CPU-intensive load and the I/O-intensive load in a range of 0% to 100% to generate a control table by measuring the number (amount) of operations based on the applied loads. For example, the hotplug controlling apparatus 100 measures the throughput of operations by applying 0% to 100% of both the processor-intensive load and the I/O-intensive load while only one of four cores (quad-core) included in the CPU is activated. Then, the hotplug controlling apparatus 100 sequentially activates another one of the four cores and applies the loads in the same manner, to measure the throughput of operations according to the number of activated cores and the types of loads and generate a control table. The generation of the control table will be described in detail later with reference to FIGS. 2 and 3.

The hotplug controlling apparatus 100 measures loads of cores in a currently executing CPU 10 to control hotplug. The hotplug controlling apparatus 100 may measure the load of each core by using Dynamic Voltage and Frequency Scaling (DVFS), and a scheduler and a separate external module may also calculate or estimate loads. Upon measuring the load of each core, the hotplug controlling apparatus 100 may calculate an amount of load of each core based on the measured load of each core, and may calculate an average value (average load) from the amounts of loads of all cores. Further, the hotplug controlling apparatus 100 may determine the types of loads of cores by analyzing the measured loads of cores. The types of loads may be divided into a processor-intensive load and an I/O-intensive load.

Upon identifying the average load and the type of load in the currently executing CPU 10, the hotplug controlling apparatus 100 compares the identified average load and type of load with the stored control table to determine an optimal number of cores. Then, based on the determined optimal number of cores, the hotplug controlling apparatus 100 switches some of two or more cores included in the CPU 10 to an active (ON) or inactive (OFF) state. The determination, by the hotplug controlling apparatus 100, of the optimal number of cores will be further described later with reference to FIGS. 2 and 3.

FIG. 2 is a detailed diagram illustrating an apparatus 100 for controlling hotplug based on load properties of a multi-core system according to an embodiment.

Referring to FIGS. 1 and 2, the apparatus 100 for controlling hotplug based on load properties of a multi-core system (hereinafter referred to as a “hotplug controlling apparatus”) includes a table generator 110, a load measurer 120, and a hotplug processor 130.

The hotplug controlling apparatus 110 measures loads of cores constituting the multi-core, and compares the average load and type of load, identified based on the measured loads, with a pre-stored control table to determine an optimal number of cores.

At the initial state of a system, or in the case where there is no control table or an update is required, the table generator 110 generates a control table in a preprocessing process. In order to generate the control table, the table generator 110 generates reference loads of different types, and applies the generated reference loads to cores. The reference load is a load applied intentionally to a core 20 during a preprocessing process of generating the control table. The throughput of operations that may be executed by each core 20 may be different depending on the types of applied loads. Particularly, the throughput of operations may be different depending on whether the type of load applied to each core is a processor-intensive load or an I/O-intensive load. Accordingly, the table generator 110 applies, to each core, reference loads which are divided into the processor-intensive load or the I/O-intensive load.

Further, the table generator 110 may generate the control table by measuring the throughput of executable operations of each core according to the applied types of loads. The control table stores the throughput of operations of cores according to the number of active cores and the types of loads. The generation of the control table will be further described later with reference to FIG. 3. The control table generated by the table generator 110 is used as a basis of comparison when a hotplug processor 130 determines an optimal number of cores.

TABLE 1
Algorithm for generating a control table

```
for cores = num(coreMIN) to num(coreMAX)
            do {
                        for cpi = CPU-bounded job to I/O-bounded
                        job
                                    save to table(num(core),
                                    load, num(ops), cpi);
                                    next cpi type;
                        end for
                        num(ops)++;
              }while(load<100);
end for
```

Table 1 shows an algorithm for generating a control table by the table generator 110. The table generator 110 generates loads in a range of 0% to 100% for all the cores 20 of the CPU 10 according to the types of loads, and generates the control table with results of executed operations.

The load measurer 120 measures loads (throughput of currently executed operations) of two or more cores 20 constituting the CPU 10. The load measured by the load measurer 120 is not a load generated by the table generator 110, but a load of the core 20 which is currently in operation (currently processing). The load measurer 120 measures the load of each core 20 and transmits the measured load to the hotplug processor 130. The load measurer 120 may measure the load of each core by using the DVFS, and a scheduler and a separate external module may also calculate or estimate the load.

In addition, the load measurer 120 identifies the types of measured loads of the cores 20, and divides the types of measured loads into a processor-intensive load and an I/O-intensive load. However, this example is merely illustrative, and the load is not limited to the two types and may vary depending on operational circumstances of a system that includes the CPU 10.

The hotplug processor 130 calculates an average amount of load based on the loads measured by the load measurer 120 to identify an amount of load currently executed by the core 20. The average amount of load is an average of loads measured for all the cores for a specific period of time. Further, the hotplug processor 130 determines an optimal number of cores by comparing the identified type of load and the calculated average amount of load with the control table. Based on the calculated average amount of load and the identified type of load, the hotplug processor 130 identifies, from the control table, a minimum number of cores that may process the average amount of load calculated from the loads having the same type as the load of the current core 20. For example, assuming that an average amount of load (amount of currently executed loads) of the current core 20 is 25000, and the type of load is a CPU-intensive load, the hotplug processor 130 identifies, from the control table, a minimum number of cores having the throughput of executable operations of 25000 or higher, which will be further described later with reference to FIG. 3.

Upon determining an optimal number of cores, the hotplug processor 130 updates the state of the cores 20 constituting the CPU 10 based on the determined optimal number of cores. The hotplug processor 130 maintains, in an active state, only the active cores 20, the number of which is the determined optimal number of cores 20, among currently active (operating) cores 20, and switches the remaining cores 20 to an inactive (Off) state.

FIG. 3 is a diagram illustrating an example of a control table of an apparatus 100 for controlling hotplug based on load properties of a multi-core system according to an embodiment.

Referring to FIG. 3, the apparatus 100 for controlling hotplug based on load properties of a multi-core system (hereinafter referred to as a “hotplug controlling apparatus”) applies reference loads having different types of maximum loads (100% load) to cores that are activated one by one, and generates a control table 300 by measuring the throughput of operations that may be executed by the cores to which the reference loads are applied. It is assumed that the control table 300 in FIG. 3 is generated by measuring a throughput (maximum number of load) of operations that may be executed when a processor-intensive load and an I/O-intensive load are applied to a system having four cores (quad-core). In the example of FIG. 3, the control table 300 is shown in the form of graph, but the example is merely illustrative for convenience of explanation, such that the control table 300 is not limited to the graph form, and may be in any form as long as the control table 300 may store information.

It can be seen from the control table 300 of FIG. 3 that the processor-intensive load (CPU-intensive throughput of operations) and the I/O-intensive load (I/O-intensive throughput of operations) are different from each other. As for the processor-intensive load, the throughput of operations with one core is 9000, which linearly increases to 36000 with four cores. By contrast, as for the I/O-intensive load, the throughput of operations is increased in a non-linear manner, in which the increased amount of the throughput of operations is reduced by the overhead.

The hotplug controlling apparatus 100 measures the amount of load (throughput of operations) currently executed by the core. Further, the hotplug controlling apparatus 100 determines the types of measured loads. For example, assuming that four cores are currently active and operating, an average amount of load (average throughput of operations) measured and calculated by the hotplug controlling apparatus 100 is 25000, and the type of load is determined to be the CPU-intensive load, the hotplug controlling apparatus 100 may compare the average load amount and the type of load with the control table, and may determine based on the comparison that three activated cores may process the throughput of operations of 27000. Accordingly, the hotplug controlling apparatus 100 determines an optimal number of cores to be 3, and switches one of four active cores to an OFF state. In this manner, the hotplug controlling apparatus 100 may identify an accurate number of cores required for the current load state, and may switch unnecessary cores to an inactive state, thereby reducing power consumption.

A performance estimation error section refers to a throughput difference between the I/O-intensive load and the CPU-intensive load in the case where each of the I/O-intensive load and the CPU-intensive load is processed by an equal number of CPUs, and refers to the throughput of operations that may vary depending on the types of loads Based on the difference of throughputs, which may vary depending on the types of loads, an optimal state may be determined to be either an active (ON) state or an inactive (OFF) state.

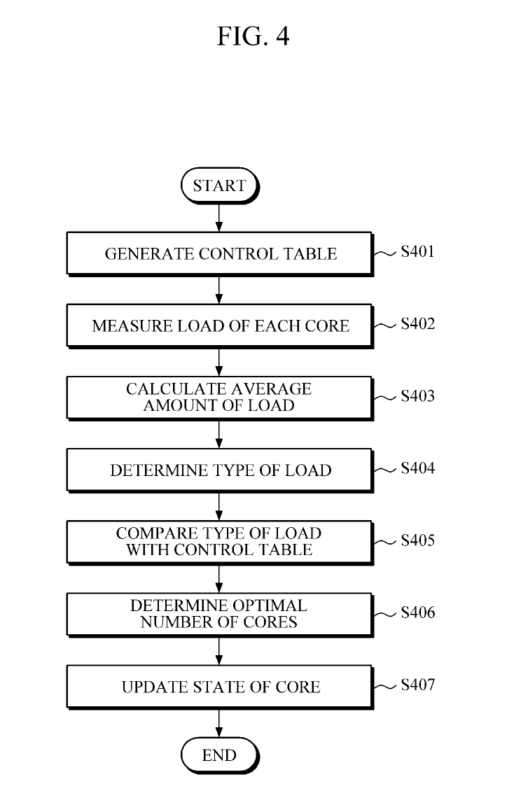

FIG. 4 is a flowchart illustrating a method of controlling hotplug that is performed by an apparatus 100 for controlling hotplug based on load properties of a multi-core system according to an embodiment.

Referring to FIG. 4, the apparatus 100 for controlling hotplug based on load properties of a multi-core system (hereinafter referred to as a “hotplug controlling apparatus) generates a control table in S401 at the state of a system or in the case where there is no control table. The hotplug controlling apparatus 100 may generate the control table by applying reference loads, which are divided into its types, to the cores and by measuring the throughput of executable operations. In the case where there is a pre-stored control table, the hotplug controlling apparatus 100 may use the pre-stored control table without generating the control table in S401.

In the case where there is a control table, the hotplug controlling apparatus 100 measures loads of currently operating cores in S402. The hotplug controlling apparatus 100 may measure the load of each core by using DVFS, or a scheduler and a separate external module may also calculate or estimate loads. Upon measuring the load of each core, the hotplug controlling apparatus 100 calculates an average amount of load, which is a throughput of operations executed for a predetermined period of time, based on the measured loads of cores in S403. Further, the hotplug controlling apparatus 100 analyzes the measured loads of cores to determine the types of the measured loads of cores in S404. The types of loads may be divided into a processor-intensive load and an I/O-intensive load, and operations S402 and S403 may be performed regardless of order.

Upon identifying an average amount of load and the types of loads of the currently active cores 20, the hotplug controlling apparatus 100 compares the identified average amount of load and the types of loads with a control table in S405, to determine an optimal number of cores in S406. The hotplug controlling apparatus 100 compares the types of loads and the number of operations that may be executed by each core included in the control table with the average amount of load and the types of loads measured by a system, to determine a minimum number of cores that may process the current load state of cores. Then, the hotplug controlling apparatus 100 updates the state of cores based on the determined optimal number of cores in S407. The hotplug controlling apparatus 100 may identify, from the control table, the minimum number of cores that may process the average amount of loads calculated from loads having the same type as the current type of load of the core 20. The hotplug controlling apparatus 100 maintains, in an active state, only the active cores, the number of which is the optimal number of cores, among the currently active (operating) cores, and switches the remaining cores to an inactive (OFF) state.

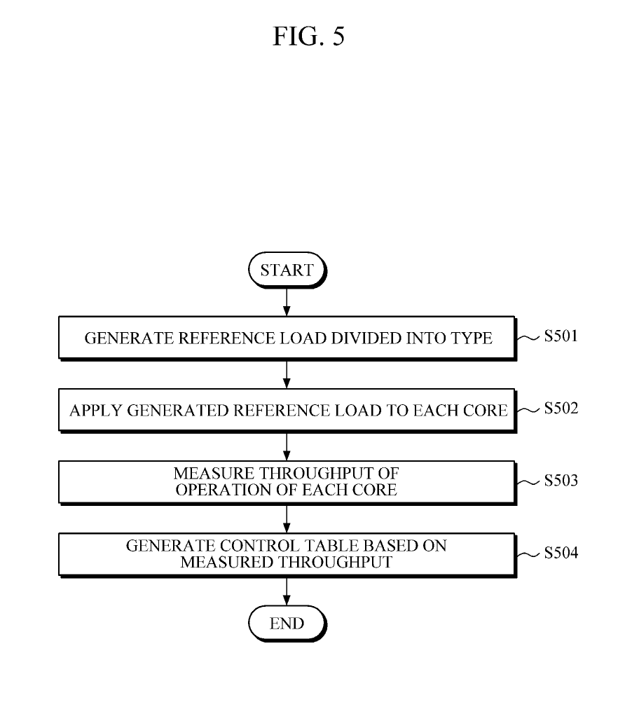

FIG. 5 is a diagram illustrating a method of generating a control table in a method of controlling hotplug based on load properties of a multi-core system according to an embodiment.

Referring to FIG. 5, the generation of a control table in S401 will be described in detail below. In order to generate a control table, the hotplug controlling apparatus 100 generates reference loads, which are divided into its types, in S501. The reference load is a load applied intentionally to a core 20 during a preprocessing process of generating the control table. The throughput of operations that may be executed by each core 20 may be different depending on the types of applied loads. Particularly, the throughput of operations may be different depending on whether the type of load applied to each core is a processor-intensive load or an I/O-intensive load. Accordingly, the hotplug controlling apparatus 100 applies the generated reference loads to each core in S502. The hotplug controlling apparatus 100 may divide the generated reference loads according to its types, and may sequentially apply the reference loads to one core after another. Upon applying the generated reference loads to each core, the hotplug controlling apparatus 100 may measure the throughput of executable operations according to the applied reference loads in S503, and generates the control table based on the measured throughput in S504. The control table generated by the hotplug controlling apparatus 100 may be used as a basis for comparison when the hotplug controller 130 determines the optimal number of cores. The generation of the control table is described above with reference to FIGS. 1 to 3.

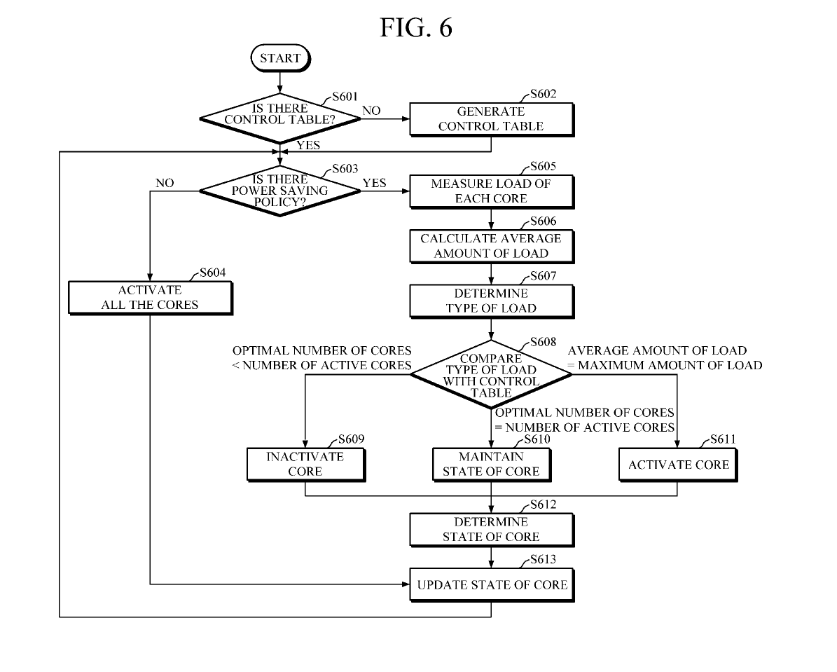

FIG. 6 is a flowchart illustrating another example of a method of controlling hotplug based on load properties of a multi-core system according to an embodiment.

Referring to FIG. 6, the hotplug controlling apparatus 100 determines whether there is a control table in a storage in S601. In response to no control table stored in the storage, the hotplug controlling apparatus 100 generates the control table in S602. The generation of the control table is described above with reference to FIGS. 1 to 5.

In the case where there is a control table, or the control table is generated in S602, the hotplug controlling apparatus 100 determines whether there is a power saving policy of a system in S603. The power saving policy is intended to reduce power consumption of a system where a multi-core processor is mounted. In the case where there is no power saving policy, the hotplug controlling apparatus 100 actives all the cores in S604 for maximum performance.

By contrast, in the case where there is a power saving policy, the hotplug controlling apparatus 100 measures loads of currently operating cores in S605. The loads of the currently operating cores refers to the number of operations currently executed by the cores. The hotplug controlling apparatus 100 may measure the loads of cores based on the number of operations currently executed by the cores. Further, the hotplug controlling apparatus 100 calculates an average amount of load from the measured loads of cores in S606, and may determine the type of loads in S607. The hotplug controlling apparatus 100 calculates the average amount of load based on the throughput of operations executed for a predetermined period of time (e.g., one second). Further, the hotplug controlling apparatus 100 determines whether the type of the measured loads is a processor-intensive load or an I/O-intensive load.

Upon calculating the average amount of load and determining the type of the measured loads, the hotplug controlling apparatus 100 compares the average amount of load and the type of load with the control table in S608. The hotplug controlling apparatus 100 identifies, from the control table, the minimum number of cores that may process the calculated average amount of load among the throughputs of operations of cores of the determined types of loads, and determines the minimum number of cores to be the optimal number of cores. The hotplug controlling apparatus 100 compares the optimal number of cores with the number of active cores. In response to the optimal number of cores being smaller than the number of active core, the hotplug controlling apparatus 100 determines to inactivate the remaining cores for better performance based on the optimal number of cores in S609. In response to the optimal number of cores being the same as the number of active cores, the hotplug controlling apparatus 100 determines that a current state is an optimal state and maintains the current state in S610.

In the case where the calculated average amount of load is the same as the maximum amount of the current cores in the control table, the hotplug controlling apparatus 100 determines to further activate cores in S611. In the case where the maximum amount of load determined for the number of currently active cores (the throughput of operations corresponding to the number of currently active cores in the control table) is the same as the calculated average amount of load, the hotplug controlling apparatus 100 may determine that the state of the currently active cores is a maximum load state, such that there is a delayed operation. Accordingly, the hotplug controlling apparatus 100 may switch the state of inactive cores to an active state, to improve processing performance of a system. The hotplug controlling apparatus 100 determines the state of cores in S612 based on the determinations made in operations S609, S610, and S611, and updates the state of cores in S613 based on the determination in S612. The hotplug controlling apparatus 100 may update the state of cores based on the determinations made in operations S609, S610, and S611, to inactivate remaining cores, or may further activate cores and maintain the current state of cores. The method of controlling hotplug based on load properties may be performed with reference to FIGS. 1 to 4.

In the apparatus and method for controlling hotplug based on load properties of a multi-core system, measured loads are compared with a control table generated during a preprocessing process to calculate an optimal number of cores, and based on the optimal number of cores, the state of a core is switched to an inactive state, so that power consumption may be reduced. Further, in the calculation of the optimal number of cores, the types of loads are divided into a CPU-intensive load and an I/O-intensive load, such that the calculation can be made more accurately since the types of currently executed tasks may be reflected in the calculation. In addition, unlike a general method, the apparatus and method for controlling hotplug based on load properties of a multi-core system directly measures loads to generate the control table and calculates the optimal number of cores, thereby calculating the optimal number of cores regardless of a processor architecture.

The present disclosure can be realized as a computer-readable code written on a computer-readable recording medium. Codes and code segments needed for realizing the present disclosure can be easily deduced by computer programmers of ordinary skill in the art. The computer-readable recording medium may be any type of recording device in which data is stored in a computer-readable manner. Examples of the computer-readable recording medium include a ROM, a RAM, a CD-ROM, a magnetic tape, a floppy disc, an optical disk, and the like. Further, the computer-readable recording medium can be distributed over a plurality of computer systems connected to a network so that a computer-readable recording medium is written thereto and executed therefrom in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. An apparatus for controlling hotplug based on load properties, the apparatus comprising:
a load measurer configured to measure loads of two or more cores constituting a multi-core, and to determine types of the measured loads of the two or more cores; and
a hotplug processor configured to determine an optimal number of cores by calculating an average amount of load from the measured loads of the two or more cores, and by comparing the calculated average amount of load and the determined types of the measured loads with a control table that stores a number of operations of cores according to types of loads.

2. The apparatus of claim 1, further comprising a table generator configured to generate the control table by generating reference loads which are divided into types, applying the generated reference loads to the two or more cores constituting the multi-core, and measuring a throughput of operations of each of the two or more cores, to which the reference loads are applied.

3. The apparatus of claim 2, wherein at the initial state of a system, or in a case where there is no control table, the table generator generates the control table.

4. The apparatus of claim 1, wherein the types of the measured loads are divided into a processor-intensive load and an I/O-intensive load.

5. The apparatus of claim 1, wherein the hotplug processor determines whether to calculate an optimal number of cores depending on whether there is a power saving policy to reduce power consumption of the multi-core.

6. The apparatus of claim 1, wherein the hotplug processor compares the average amount of load with the throughput of operations corresponding to the determined types of loads in the control table, identifies a minimum number of cores, which process the calculated average amount of load, from the control table, and determines the minimum number of cores to be the optimal number of cores.

7. The apparatus of claim 1, wherein the hotplug processor compares the determined optimal number of cores with a number of currently active cores to control each of the two or more cores.

8. The apparatus of claim 7, wherein in response to the optimal number of cores being smaller than the number of currently active cores, the hotplug processor switches active cores to an inactive state, a number of the active cores being a number determined based on a difference between the optimal number of cores and the number of currently active cores.

9. The apparatus of claim 7, wherein in response to the average amount of load being identical to the throughput of operations in the control table, the hotplug processor switches the inactive cores to an active state.

10. A method of controlling hotplug based on load properties, the method comprising:
measuring loads of two or more cores constituting a multi-core;
determining types of the measured loads of the two or more cores;
calculating an average amount of load from the measured loads of the two or more cores; and
determining an optimal number of cores by comparing the calculated average amount of load and the determined types of the measured loads with a control table that stores a number of operations of cores according to types of loads.

11. The method of claim 10, further comprising generating the control table by generating reference loads which are divided into types, applying the generated reference loads to the two or more cores constituting the multi-core, and measuring a throughput of operations of each of the two or more cores, to which the reference loads are applied.

12. The method of claim 11, wherein the generating of the control table comprises generating the control table at the initial state of a system, or in a case where there is no control table.

13. The method of claim 11, wherein the types of the measured loads are divided into a processor-intensive load and an I/O-intensive load.

14. The method of claim 10, wherein the determining of an optimal number of cores comprises:
comparing the average amount of load with the throughput of operations corresponding to the determined types of loads in the control table;
identifying, from the control table, a minimum number of cores that process the calculated average amount of load based on the comparison; and
determining the minimum number of cores to be the optimal number of cores.

15. The method of claim 10, further comprising comparing the determined optimal number of cores with a number of currently active cores to control each of the two or more cores.

16. The method of claim 15, wherein in response to the optimal number of cores being smaller than the number of currently active cores, the controlling of each of the two or more cores comprises switching, to an inactive state, a number of active cores which is a number determined based on a difference between the optimal number of cores and the number of currently active cores.

17. The method of claim 15, wherein in response to the average amount of load being identical to the throughput of operations in the control table, the controlling of each of the two or more cores comprises switching the inactive cores to an active state.
